(19) United States
(12) Patent Application Publication
(10) Pub. No.: US 2024/0404020 A1
(43) Pub. Date: Dec. 5, 2024

(54) PROCESSING METHOD AND APPARATUS, AND ELECTRONIC DEVICE

(71) Applicant: Lenovo (Beijing) Limited, Beijing (CN)

(72) Inventor: Rui WANG, Beijing (CN)

(21) Appl. No.: 18/678,860

(22) Filed: May 30, 2024

(30) Foreign Application Priority Data
May 31, 2023 (CN) 202310632292.X

(51) Int. Cl. G06T 5/70; G06T 7/10

(52) U.S. Cl. CPC G06T 5/70; G06T 7/10; G06T 2207/10028; G06T 2207/20161

(57) ABSTRACT

A processing method includes obtaining a frame of an original image in a spatial environment, based on depth information of imaging objects in the original image, associating the imaging objects with a plurality of layers of the original image, and performing corresponding image processing on a target object in a target layer according to the depth information to obtain a frame of a target image. The plurality of layers have a difference in a depth direction.

### CROSS-REFERENCE TO RELATED APPLICATION

The present disclosure claims priority to Chinese Patent Application No. 202310632292.X, filed on May 31, 2023, the entire content of which is incorporated herein by reference.

### TECHNICAL FIELD

The present disclosure is related to the image processing technology field and, more particularly, to a processing method, a processing apparatus, and an electronic device.

### BACKGROUND

Currently, in image processing, an object in an image cannot be accurately processed in some situations, such as in the situation of erasing a plurality of foreground moving objects. It is desired to solve this problem.

### SUMMARY

An aspect of the present disclosure provides a processing method. The method includes obtaining a frame of an original image in a spatial environment, based on depth information of imaging objects in the original image, associating the imaging objects with a plurality of layers of the original image, and performing corresponding image processing on a target object in a target layer according to the depth information to obtain a frame of a target image. The plurality of layers have a difference in a depth direction.

An aspect of the present disclosure provides a processing apparatus, including an acquisition module, an association module, and a processor. The acquisition module is configured to obtain a frame of an original image in a spatial environment. The association module is configured to, based on depth information of imaging objects in the original image, associate the imaging objects with a plurality of layers of the original image. The plurality of layers have a difference in a depth direction. The processor is configured to perform corresponding image processing on a target object in a target layer according to the depth information to obtain a frame of a target image.

An aspect of the present disclosure provides an electronic device, including one or more processors and one or more memories. The one or more memories store a computer instruction set that, when executed by the one or more processors, causes the one or more processors to obtain a frame of an original image in a spatial environment, based on depth information of imaging objects in the original image, associate the imaging objects with a plurality of layers of the original image, and perform corresponding image processing on a target object in a target layer according to the depth information to obtain a frame of a target image. The plurality of layers have a difference in a depth direction.

### BRIEF DESCRIPTION OF THE DRAWINGS

FIG. 1 illustrates a schematic flowchart of a processing method according to some embodiments of the present disclosure.

FIG. 2 illustrates a schematic flowchart of associating an imaging object to a corresponding image layer of an original image according to some embodiments of the present disclosure.

FIG. 3 illustrates a schematic flowchart of performing corresponding image processing on a target object at a target image layer according to some embodiments of the present disclosure.

FIG. 4 illustrates a schematic diagram of image processing according to some embodiments of the present disclosure.

FIG. 5 illustrates a schematic structural diagram of a processing apparatus according to some embodiments of the present disclosure.

FIG. 6 illustrates a schematic structural diagram of an electronic device according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. The described embodiments are merely some embodiments of the present disclosure, not all embodiments. Based on embodiments of the present disclosure, all other embodiments obtained by those skilled in the art without creative efforts are within the scope of the present disclosure.

The present disclosure provides a processing method, a processing apparatus, and an electronic device for solving the technical problem of being unable to accurately perform required image processing on an object in an image with the existing technology. The processing method can be applied to electronic devices with many general-purpose or special-purpose computing apparatus environments or configurations, e.g., a personal computer, a server computer, a handheld device or a portable device, a tablet device, a multi-processor apparatus, etc.

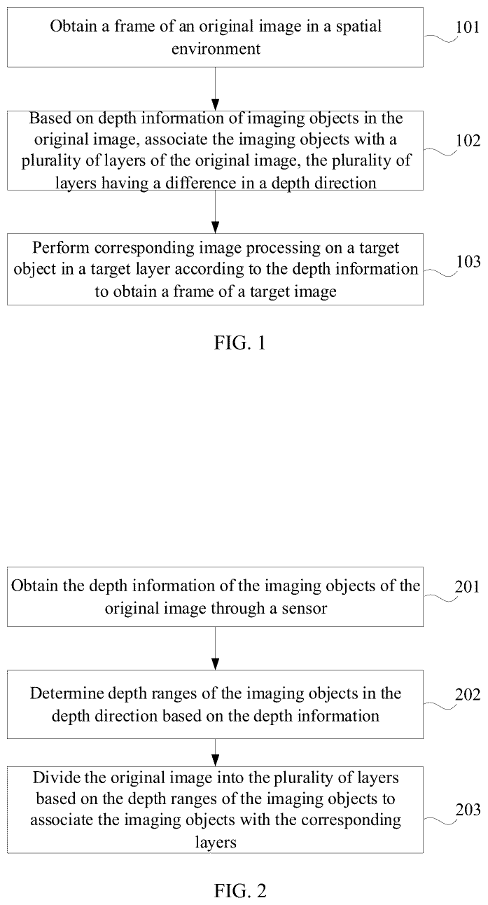

FIG. 1 illustrates a schematic flowchart of a processing method according to some embodiments of the present disclosure. The method includes the following steps.

At 101, a frame of an original image in a spatial environment is obtained.

A frame of the original image in the spatial environment can refer to a frame of the original image obtained by performing imaging on an object in the spatial environment. In some embodiments, the frame of the original image can be collected by photographing the object in the spatial environment using a camera device/camera (e.g., a cellphone camera) or other image devices. In some other embodiments, the frame of the original image can be from a video stream collected by performing video recording on the object in the spatial environment, which is not limited here.

In image processing, according to actual image processing requirements, the corresponding frame of the original image of the image or video stream can be obtained through photography or video recording. The image processing can include but is not limited to one or more of erasing, blurring, enhancement, trapezoidal correction, etc.

In some embodiments, the obtained frame of the original image can be a GRB (Red-Green-Blue) color image, or a non-GRB image such as a grayscale image, which is not limited here. In the present disclosure, the original image as the GRB color image is taken as an example for description.

At 102, an imaging object is associated with a plurality of layers of the original image at least based on depth information of the imaging object in the original image, and the plurality of layers have at least differences in depth directions.

A depth direction can refer to a direction where a distance between the imaging object in front of a camera lens or other imagers and a photosensitive surface is located. The depth information of the imaging object can be used to represent the distance between the imaging object and the photosensitive surface. The larger the distance is, the greater the value of the depth information is, and vice versa.

In some embodiments, when image collection is performed on the imaging object, the depth information of the imaging object in the original image can be obtained through at least one sensor. The at least one sensor can include but is not limited to any one or more of a D-camera, a Time of flight (TOF) camera, and an infrared (IR) camera.

In some embodiments, when the image information of the imaging object is collected using an imager such as an RGB camera to perform imaging on the imaging object, a depth image of the imaging object can be simultaneously collected based on any one or more of the above sensors. The depth image can include depth information of each pixel of the imaging object. After the RGB original image and the depth image are simultaneously collected, the depth information of each pixel in the RGB original image can be obtained by aligning the RGB original image and the depth image. Thus, the depth information of the imaging object in the original image can be obtained.

A layout position of the imager such as the RGB camera and the depth sensor such as D-camera, TOF camera, and IR camera can satisfy a neighboring condition. For example, the distance between the RGB camera and the TOF camera can be 0 or less than a predetermined distance value.

In some embodiments, after the depth information of the imaging object in the original image is obtained, the imaging object can be associated with the plurality of layers of the original image at least based on the depth information of the imaging object in the original image. In some embodiments, according to the depth information of the imaging object in the original image, the depth direction of the imaging object in the original image can be divided into a plurality of layers. Different layers can at least have differences in the depth directions. Thus, the imaging object can be associated with a corresponding layer of the original image.

One imaging object can be located on one layer of the original image. That is, if a certain layer of the original image includes image information of a certain imaging object, the layer can include the entire image information of the imaging object to ensure that the object is not separated with divided layers.

At 103, corresponding image processing is performed on the target object in the target layer using the depth information to obtain a frame of the target image.

The target layer can be a layer where the target object is located or with which the target object is associated.

The target object can include all imaging objects in the original image or some imaging objects that are selected, which is not limited here. In some embodiments, the imaging objects can include one or more imaging objects that are selected from the original image and match a desired object feature based on feature matching or model (e.g., deep neural network model) intelligent recognition or one or more imaging objects located at a desired position (e.g., a foreground position and a background position), which is not limited here.

After the imaging object is associated with the corresponding layer of the original image at least based on the depth information of the imaging object in the original image, further performing corresponding image processing on the target object in the target layer using the depth information of the target object can include but is not limited to one or more of erasing, blurring, enhancement, or trapezoidal correction. In some embodiments, the target object can be accurately positioned in the target layer according to the depth information of the target object. For example, the target object can be recognized and positioned in the target layer in connection with the depth information of the target object and an edge recognition algorithm. Thus, required processing such as easing, blurring, enhancement, and trapezoidal correction can be performed on the recognized and positioned target object in the target layer. Moreover, based on the processing result, the frame of the target image can be obtained. the target image can be output as an output image of the image processing.

In image processing, the required processing cannot be performed accurately on the object in the image with the existing technology in some situations, e.g., erasing the moving object in the foreground when a plurality of moving objects are included. In this situation, due to overlapping, blocking, or adjacency of the image information of the plurality of moving objects, a to-be-processed foreground moving object cannot be accurately positioned. Thus, erasing can not be accurately performed on the to-be-processed foreground moving object.

In the processing method of the present disclosure, after obtaining the frame of the original image in the spatial environment, the imaging objects can be associated with the plurality of layers (the plurality of layers having at least differences in the depth directions) of the original image at least based on the depth information of the imaging objects in the original image. The corresponding image processing can be performed on the target object at the target layer to effectively solve the problem. Different imaging objects can be associated with corresponding layers of the original image according to the depth information of the imaging objects to further differentiate the different imaging objects in depth dimensions based on the different layers where the imaging objects are. Thus, inaccurate recognition and positioning of the imaging object due to the overlapping, blocking, and adjacency of the image information of the different objects in the original image can be avoided, and the image processing such as erasing, trapezoidal correction can be accurately performed on the image information of the imaging object. Then, the accuracy of the image processing can be improved to better satisfy the image processing requirements.

In some embodiments, as shown in FIG. 2, in step 201, associating the imaging objects with the plurality of layers of the original image based on the depth information of the imaging objects in the original image can further include the following steps.

At 201, the depth information of the imaging objects in the original image is obtained through at least one sensor.

Based on the above, the depth information of the imaging objects in the original image can be obtained by using at least one sensor when the image collection is performed on the imaging objects.

For example, when the imaging information of the imaging objects is collected through the imager such as the RGB camera to imaging the imaging object, the depth image of the imaging objects can be simultaneously collected based on one or more sensors of the D-camera, TOF camera, or IR camera. The depth image can include the depth information of each pixel of the image objects. After synchronously collecting the original image such as the RGB image and the depth image, the original image such as the RGB image and the depth image can be aligned to obtain the depth information of each pixel of the original image such as the RGB image to obtain the depth information of the imaging object in the original image.

At 202, the depth ranges of the imaging objects are determined in the depth direction based on the depth information.

In some embodiments, in connection with the depth information corresponding to the pixels in the original image and the edge detection results of the imaging objects obtained by performing edge detection on the original image based on the edge detection algorithm, e.g., edge pixel position information of the imaging objects, the depth ranges corresponding to the imaging objects can be determined in the original image.

For the situation that the edge of the imaging object cannot be accurately recognized due to the overlapping, blocking, or adjacency of the image information of the plurality of imaging objects in the original image, the edge of the same imaging object can be recognized based on a depth information continuous feature of the same imaging object. Then, the depth ranges corresponding to the imaging objects in the depth direction can be determined based on the recognized edge and the depth information of the pixels at the edge. For example, depth value difference calculation can be performed on the pixel with the largest depth value and the pixel with the smallest depth value on the edge of a certain imaging object, and the obtained difference calculation result can be used as the depth range corresponding to the imaging object in the depth direction.

At 203, the original image is divided into a plurality of layers based on the depth ranges of the imaging objects to associate the imaging objects in the original image with the corresponding layers.

After determining the depth ranges corresponding to the imaging objects in the depth direction, the original image can be further divided into the plurality of layers based on the depth ranges corresponding to the imaging objects in the depth direction.

In some embodiments, according to the depth ranges corresponding to the imaging objects in the depth direction, depth sections used to perform layer division can be determined, and image information of each depth section can be divided into one layer to obtain the plurality of layers of the original image.

Each determined depth section can at least include a depth range corresponding to an entire imaging object in the depth direction. In some embodiments, Each depth section can include a depth range corresponding to an entire imaging object in the depth direction. For example, the depth range can be equal to the depth range corresponding to the entire imaging object in the depth direction included in the depth section or greater than the depth range corresponding to the entire imaging object in the depth direction included in the depth section and have a range difference with the depth range corresponding to the entire imaging object included in the depth section smaller than a determined section length, which is not limited here.

By dividing the original image into the plurality of layers based on the depth ranges of the imaging objects, the imaging objects in the original image can be associated with the corresponding layers. In some embodiments, different imaging objects can be associated with different layers as much as possible. Thus, accurate image processing can be performed on the target object at the target layer according to the depth information of the pixels of the imaging object.

In some embodiments, in step 201, based on the depth information of the imaging objects in the original image and in connection with the moving information of the imaging objects and/or the position areas of the imaging objects in the original image, the imaging objects can be associated with the plurality of layers of the original image, which can be further implemented in any of the following methods.

In method 1, the original image is divided into a plurality of layers based on the moving information and the depth information of the imaging object to associate the imaging objects in the original image with the corresponding layers.

The moving information of the imaging objects can be used to represent moving statuses of the imaging objects. The moving status can include any one of a static status or a moving status (e.g., a uniform motion, accelerated/decelerated motion, linear motion, curved motion, etc.).

The moving information of the imaging object in the original image can be determined by comparing and performing a related calculation on the image information and/or depth information of the currently obtained original image and the previous frame of the original image (e.g., in the situation that the to-be-processed image includes the images in the video stream or a plurality of continuous images). In some other embodiments, the moving information of the imaging object can be determined by performing moving feature analysis on the currently obtained original image (e.g., in the situation that the to-be-processed image includes the images in the video stream or the plurality of continuous images or only one frame of image). The moving feature analysis can include but is not limited to blur analysis, object type analysis, and motion trail analysis of the imaging objects. By analyzing whether the type of the imaging object in the obtained frame of the original image belongs to a moving object type (e.g., a human body generally belonging to the moving object), whether the imaging object has a motion trail effect, and whether the imaging object has sufficient blur, the moving information of the imaging object can be recognized.

The moving information of the imaging object can include but is not limited to the imaging object belonging to the static type or the moving type and a moving pixel area, a moving speed, a moving distance, and a depth change corresponding to the moving type.

After obtaining the moving information of the imaging object, contour information of the imaging object can be determined according to the moving information of the imaging object in the original image and the object recognition algorithm that is currently obtained. In some embodiments, the contour information of the imaging object can include contour information of the imaging object in the depth direction and contour information of the imaging object in a direction perpendicular to the depth direction. In some embodiments, the object recognition can be performed on the currently obtained original image using the object recognition algorithm. Based on the object recognition result and in connection with the moving information of the imaging object, the contour information of the imaging object in the depth direction and the contour information of the imaging object in the direction perpendicular to the depth direction can be determined. For example, assume that the human body is in front a whiteboard. After the human body moves, a human body recognition result can be determined based on the human body recognition algorithm. The contour information of the human body in the depth direction and the contour information in the direction perpendicular to the depth direction can be determined based on the human body recognition result and in connection with the depth information and the depth change of the moving pixel area of the human body and/or the whiteboard.

The object recognition algorithm can be but is not limited to an object recognition algorithm based on a matching feature or a model (e.g., deep neural network model) intelligent recognition.

Then, the depth ranges of the imaging objects in the depth direction can be determined based on the contour information and the corresponding depth information, and the original image can be divided into the plurality of layers based on the depth ranges of the imaging objects in the depth direction.

For example, the depth value difference calculation can be performed on the pixel with the largest depth value and the pixel with the smallest depth value at the contour of the imaging object such as the human body represented by the contour information. The difference calculation result can be used as the depth range corresponding to the imaging object such as the human body. Thus, the depth sections used to perform layer division can be determined according to the depth ranges corresponding to the imaging objects. The image information of each depth section can be divided into one layer to obtain the plurality of layers of the original image.

Based on the above, each determined depth section can at least include a depth range of an entire imaging object in the depth direction. In some embodiments, each depth section can include the depth range corresponding to the entire imaging object in the depth direction, which is equal to the depth range corresponding to the entire imaging object included in the depth section in the depth direction, or can be greater than the depth range corresponding to the entire object included in the depth section in the depth direction and have a range difference with the depth range corresponding to the entire object included in the depth section smaller than the determined section length, which is not limited here.

In method 2, the original image is divided into the plurality of layers based on the position areas and depth information of the imaging objects in the original image to associate the imaging objects in the original image with the corresponding layers.

In method 2, the imaging objects in the original image can be recognized using the object recognition algorithm, and the position areas corresponding to the imaging objects can be determined.

Based on this, boundary points of the imaging objects can be determined based on the position areas of the imaging objects in the original image. Based on the depth information corresponding to the boundary points of the imaging objects, the depth ranges of the imaging objects can be determined in the depth direction to further divide the original image into the plurality of layers based on the depth ranges of the imaging objects.

For example, a depth value different calculation can be performed on a boundary point with the largest depth value and a boundary point with the smallest depth value in the boundary points of the imaging object, and the different calculation results can be used as the depth range corresponding to the imaging object. Thus, according to the depth ranges corresponding to the imaging objects, the depth sections used to perform layer division can be determined. The image information of each depth section can be divided into one layer to obtain the plurality of layers of the original image.

For the depth section, reference can be made to the related description of embodiments of the present disclosure, which is not repeated here.

In method 3, the original image is divided into the plurality of layers based on the moving information of the imaging objects, the position area of the imaging objects in the original image, and the depth information of the imaging objects to associate the imaging objects of the original image to the corresponding layers.

Method 1 and method 2 are combined in method 3. According to the moving information of the imaging objects, the position areas of the imaging objects in the original image, and the depth information of the imaging objects, the original image can be divided into the plurality of layers.

In method 3, the imaging objects of the original image can be recognized using the object recognition algorithm in advance to determine the position areas corresponding to the imaging objects. By comparing and performing related calculation on the image information and/or the depth information of the currently obtained original image with the previous frame of the original image, the moving information of the imaging objects in the original image that is currently obtained can be determined.

Based on this, the contour information of the imaging object can be determined according to the moving information of the imaging object and the object recognition algorithm, and the boundary points of the imaging object can be determined based on the position area corresponding to the imaging object. In connection with the contour information and the boundary points of the imaging object, the pixel with the largest depth value and the pixel with the smallest depth value of the imaging object can be determined. In some embodiments, the pixel with the largest depth value and the pixel with the smallest depth value can be corresponding points in the pixels at the contour of the imaging object represented by the contour information and the pixels represented by the boundary points.

Then, the depth value calculation can be performed on the pixel with the largest depth value and the pixel with the smallest depth value of the imaging object to obtain the depth range of the imaging object to determine the depth sections used to perform layer division according to the depth ranges corresponding to the image objects. The image information of each depth section can be divided into one layer to obtain the plurality of layers of the original image.

In some embodiments of the present disclosure, the original image can be divided into layers in the depth direction through the division according to the static and moving of the image objects of the original image and/or the division according to the entirety of the imaging objects represented by the position areas of the image objects. Thus, the entire image information of each imaging object can be divided into the same layer, and the object can be ensured not to be separated by dividing the original image into layers. That is, the imaging object may not be divided into different layers. Thus, accurate image processing can be subsequently performed on the target object at the target layer according to the depth information of the pixels of the image object.

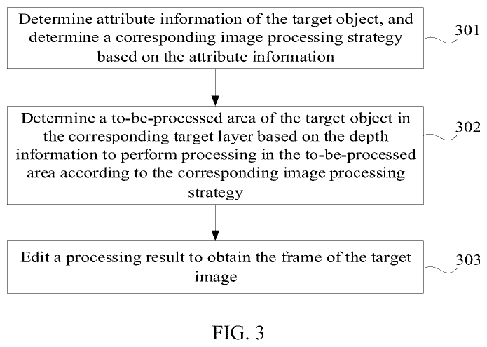

In some embodiments, as shown in FIG. 3, step 103 of performing the corresponding image processing on the target object at the target layer according to the depth information to obtain the frame of the target image includes the following steps.

At 301, attribute information of the target object is determined, and a corresponding image-processing strategy is determined based on the attribute information.

The target layer can correspond to the target object in a one-to-one correspondence. One or more target layers or target objects can be provided.

The attribute information of the target object is not limited to the type attribute of the target object. The attribute information can be one or more of types or position attributes corresponding to the target object in the original image.

The type attribute of the target object can be used to represent the object type of the target object, such as human, whiteboard, PPT, and displayed item. The status attribute of the target object can be used to represent whether the target object is in the moving or static status. The position attribute of the target object can be used to represent the position corresponding to the target object in the original image, e.g., the corresponding foreground position or the background position.

In some embodiments, the attribute information such as the object type, the status type, or the position of the target object in the original image can be first determined. Then, the image processing strategy corresponding to the attribute information of the target object can be determined.

In some embodiments, the corresponding image processing strategy can be pre-set relatedly for different attribute information to form and store the corresponding strategy setting information. Thus, after the attribute information of the target object is determined, the image processing strategy matching the attribute information of the target object can be determined according to the stored strategy setting information. For example, for the foreground moving object, e.g., the human body, an image processing strategy such as foreground moving object erasing or enhancement can be determined. For the background object, e.g., the whiteboard, an image processing strategy such as background erasing or blurring can be determined. For the object type of PPT, an image processing strategy such as the trapezoidal correction can be determined.

At 302, based on the depth information, the to-be-processed area in the target layer corresponding to the target object is determined to perform processing in the to-be-processed area using the corresponding image processing strategy.

Based on the depth information of the target object, the to-be-processed area in the target layer corresponding to the target object can be determined. In some embodiments, based on the depth information of the target object, and in connection with the object contour information determined using the object recognition algorithm, or in connection with the object edge information recognized using the edge recognition algorithm, the to-be-processed area of the target object in the corresponding target layer can be determined. For example, in connection with depth information and contour/edge information of the imaging object such as the human body or the whiteboard, the to-be-processed area of the human body or the whiteboard can be determined in the corresponding target layer.

Based on this, processing can be performed on the image information of the target object in the to-be-processed area using the corresponding image-processing strategy. For example, the image information of the to-be-processed area can be erased, or the blurring and trapezoidal correction can be performed on the image information of the to-be-processed area.

At 303, the processing result is edited to obtain the frame of the target image.

The processing result can be used to represent a result obtained by performing the image processing according to the corresponding image processing strategy in the to-be-processed area in the target layer. That is, the processing result can represent the target layer after the image processing is completed.

After the processing is performed in the to-be-processed area with the corresponding image processing strategy to obtain the processing result, editing the processing result can include but is not limited to fusing the target layer after the image processing is completed with other layers according to a sequence of the layers in the depth direction of the original image, splicing the layers according to the corresponding positions in the original image, or directly deleting the target layer to obtain the frame of target image for output.

For example, for the background blurring, the background object layer obtained after performing the background object blurring can be fused with other layers according to the sequence of the layers in the depth direction of the original image to obtain the frame of the target image for output.

In some embodiments, the to-be-processed area of the target object in the corresponding target layer can be determined based on the depth information of the target object. The image processing can be performed in the to-be-processed area with the corresponding image processing strategy. Thus, the false processing of the image information of another layer can be avoided. Since the object is not separated in the layer division, the entire target object can be ensured to be processed in the to-be-processed area in the target layer to improve the accuracy of the image processing of the target object and better satisfy the image processing requirements.

In some embodiments, according to the depth information of the first target object, the trapezoidal correction can be performed on the first target object in the first target layer. Further, the to-be-processed area of the first target object can be determined in the corresponding target layer based on the depth information of the first target object, and the trapezoidal correction can be performed on the first target object in the to-be-processed area.

The first target object can include but is not limited to the imaging objects of the display type such as the whiteboard and PPT.

In some embodiments, the image processing strategy corresponding to the first target object can be the trapezoidal correction. The image processing strategy can be determined according to the attribute information of the first target object. For example, the correspondence between the attribute information of “display type” and the image processing strategy of “trapezoidal correction” can be preset. When the attribute of the imaging object is recognized as the display type such as the whiteboard and the PPT, the image processing strategy can be determined as “trapezoidal correction.”

In some embodiments, based on the position information and the depth information corresponding to the at least some pixels of the first target object in the to-be-processed area, position restoration corresponding to the target view angle can be performed on the at least some pixels of the first target object in the to-be-processed area to perform the trapezoidal correction on the first target object.

The target view angle can be a front view angle of the first target object, or a view angle satisfying a close condition with the front view angle of the first target object. The close condition can include a view angle deviation between the target view angle and the front view angle of the first target object being smaller than a set angle value.

One or more first target objects can be provided. For example, the first target object can be all imaging objects in the original image or a certain imaging object satisfying the set object feature. One or more target layers where the first target objects are located can be provided. When a plurality of target layers are provided, the trapezoidal correction can be performed on the different first target objects at corresponding to-be-processed areas in the target layers corresponding to the different first target objects.

In embodiments of the present disclosure, the original image can be divided into the plurality of layers according to the depth information of the imaging objects. The trapezoidal correction can be performed on the first target object in the corresponding to-be-processed area of the first target object in the target layer. Thus, the problem of inaccurately performing the trapezoidal correction on the first target object due to the overlapping, blocking, and adjacency between the image information of the different imaging objects can be avoided, and the accuracy of performing the trapezoidal correction on the first target object can be improved.

In some embodiments, performing the corresponding image processing on the target object in the target layer according to the depth information can include the following processes.

Based on the depth information of the second target object, the second target object can be erased in the target layer of the second target object.

The second target object can be but is not limited to a foreground moving object, such as the human body walking in front of the whiteboard. One or more second target objects can be provided. One or more of the target layers where the second target objects are located can be provided. Each second target object can correspond to one target layer.

In some embodiments, the image processing strategy corresponding to the second target object can be erasing. The image processing strategy can be determined according to the attribute information of the second target object. For example, the correspondence between attribute information of the “foreground moving object” and the image processing strategy of “erasing” can be preset. When the attribute of the imaging object is recognized to be the foreground moving object, the image processing strategy can be determined as “erasing.”

When performing the erasing, for the second target object such as the foreground moving object, the to-be-processed area of the second target object in the corresponding target layer can be determined based on the depth information of the second target object. For example, based on the depth information of the second target object, and in connection with the contour information of the second target object determined using the object recognition algorithm, or in connection with the edge information of the second target object recognized by the edge recognition algorithm, the to-be-processed area of the second target object can be determined in the corresponding target layer, and the second target object can be erased in the to-be-processed area.

For example, the human body image information can be erased in corresponding to-be-processed area of the human body in the target image.

When a plurality of second target objects and a plurality of target layers are provided, the image information of different second target objects can be erased in corresponding to-be-processed areas of the different second target objects in the corresponding target layers.

Based on depth information of a third target object, erasing or blurring can be performed on the third target object in the target image where the third target object is located.

The third target object can include but is not limited to the background object, e.g., the whiteboard behind the human body. One or more third target objects can be provided. Correspondingly, one or more target layers where the third target objects are located can be provided. Each third target object can correspond to one target layer.

In some embodiments, the image processing strategy corresponding to the third target object can be erasing or blurring. The image processing strategy can be determined according to the attribute information of the third target object. In some embodiments, the correspondence between the attribute information of “background object” and the image processing strategy “erasing or blurring” can be preset. When the attribute of the imaging object is recognized as the background object, the image processing strategy can be determined as “erasing or blurring.”

For the third target object such as the background object, the to-be-processed area of the target object can be determined in the corresponding target layer based on the depth information of the third target object. For example, based on the depth information of the third target object, and in connection with the contour information of the third target object determined by using the object recognition algorithm or the edge information of the third target object recognized by using the object recognition algorithm, the to-be-processed area of the third target object can be determined in the target layer. The erasing or blurring can be performed on the image information of the third target object in the to-be-processed area.

For example, the image information of the whiteboard can be erased in the corresponding to-be-processed area in the target image where the whiteboard is located, or the image information of the whiteboard can be blurred.

In embodiments of the present disclosure, the original image can be divided into the plurality of layers according to the depth information of the imaging object. The foreground/background erasing or blurring can be performed on the second target object/the third target object in the corresponding to-be-processed areas of the first target object/the third target object in the target layers. Thus, the problem of performing inaccurate erasing or blurring on the foreground/background object due to the overlapping, blocking, and adjacency between the image information of different imaging objects can be avoided. The accuracy of performing the erasing or blurring on the foreground/background object can be improved.

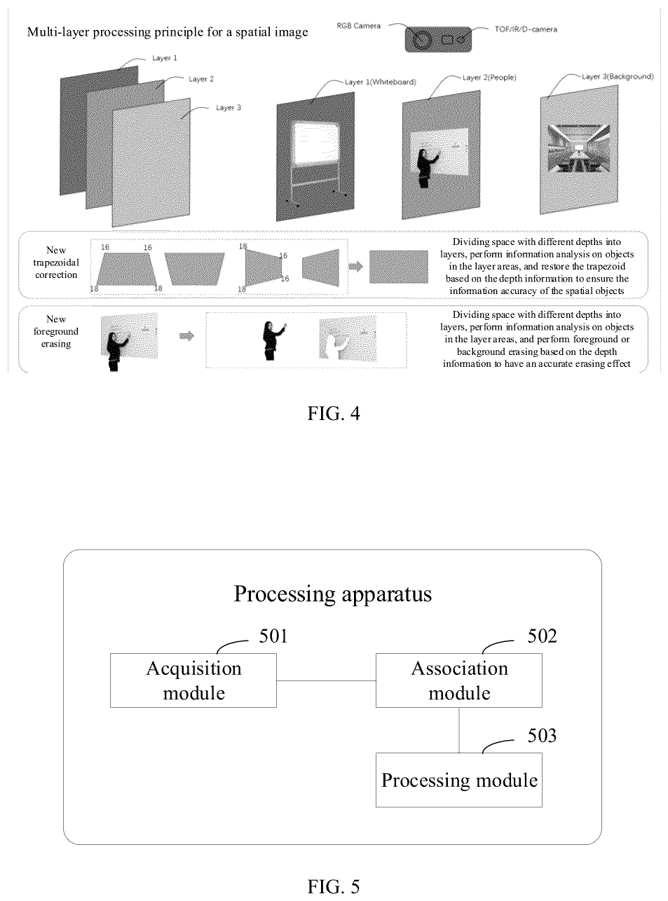

FIG. 4 illustrates a schematic diagram of image processing according to some embodiments of the present disclosure. As shown in FIG. 4, the object in the spatial environment includes a whiteboard, a moving teacher, and an object of the related scenario. When the object in the spatial environment is imaged using an imager such as an RGB camera, the depth information of the object in the spatial environment can be collected simultaneously using a depth sensor such as the D-camera, TOF camera, and IR camera. Thus, the RGB image and the depth image of the object in the spatial environment can be obtained. By aligning the RGB image and the depth image, the depth information of each imaging object of the RGB image can be obtained.

Based on this, as shown in FIG. 4, the original image of the RGB image can be divided into three layers at least based on the depth information of the imaging object, including layer1 where the whiteboard is located, layer2 where the teacher is located, and layer3 where other background objects are located. The corresponding imaging object can be determined as the target object based on the requirements. The corresponding image processing can be performed according to the corresponding image processing strategy in the corresponding to-be-processed area in the target layer where the target object is located.

For example, all the imaging objects can be used as the first target objects, and the trapezoidal correction can be performed in the corresponding to-be-processed area of each first target object in the target layer. In some other embodiments, the foreground moving object such as the moving teacher can be used as the second target object. Image erasing can be performed in the corresponding to-be-processed area of the second target object in the target layer to erase the human body image, and/or the background object such as the whiteboard can be used as the third target object. Background blurring can be performed in the corresponding to-be-processed area of the third target object at the target layer.

When the obtained original image is a certain frame image from a to-be-processed video stream, i.e., the to-be-processed image includes the frames of the image from the to-be-processed video stream, each frame of the original image can be obtained from the to-be-processed video stream as the current to-be-processed image. according to the processing method of the present disclosure, by aligning the to-be-processed image and the depth image that is simultaneously collected, the depth information of the imaging object of the current to-be-processed image can be obtained. the current to-be-processed image can be divided into the plurality of layers at least based on the depth information of the imaging objects in the current to-be-processed image. Then, the corresponding image processing can be performed on the target object at the target layer by using the depth information of the target object in the current to-be-processed image, such as foreground object erasing, background object blurring, and trapezoidal correction. Thus, the one frame of the target image corresponding to the current to-be-processed image can be obtained.

After processing the frames of images of the to-be-processed video stream to obtain the one frame of the target image corresponding to each frame of the image. The target images corresponding to the frames of the image can form a target video stream sequentially, and the target video stream can be used as a processing result of the to-be-processed video stream for output.

For the processing method above, embodiments of the present disclosure further provide a processing apparatus. The processing apparatus has a structure as shown in FIG. 5. The processing apparatus can include an acquisition module 501, an association module 502, and a processing module 503.

The acquisition module 501 can be configured to obtain a frame of the original image in the spatial environment.

The association module 502 can be configured to associate the imaging objects with the plurality of layers of the original image at least based on the depth information of the imaging objects in the original image. The plurality of layers can at least have differences in the depth direction.

The processing module 503 can be configured to perform the corresponding image processing on the target object in the target layer using the depth information to obtain the one frame of the target image.

In some embodiments, the association module 502 can be further configured to obtain the depth information of the imaging objects in the original image through at least one sensor, determine the depth ranges of the imaging objects in the depth direction based on the depth information, and divide the original image into the plurality of layers based on the depth ranges of the imaging objects to associate the imaging objects with the corresponding layers.

In some embodiments, the association module 502 can be further configured to divide the original image into the plurality of layers based on the moving information and the depth information of the imaging objects to associate the imaging objects with the corresponding layers, the moving information being used to represent the moving statuses of the imaging objects, divide the original image into the plurality of layers based on the position areas and the depth information of the imaging objects in the original image, or divide the original image into the plurality of layers based on the moving information of the imaging objects, and the position areas and the depth information of the imaging objects in the original image to associate the imaging objects with the corresponding layers.

In some embodiments, the association module 502 can be further configured to, when dividing the original image into the plurality of layers based on the moving information and the depth information of the imaging objects, determine the contour information of the imaging objects according to the moving information of the imaging objects and the object recognition algorithm, determine the depth ranges of the imaging objects in the depth direction based on the contour information and the corresponding depth information, and divide the original image into the plurality of layers based on the depth ranges of the imaging objects.

In some embodiments, the association module 502 can be further configured to, when dividing the original image into the plurality of layers based on the position areas and the depth information of the imaging objects in the original image, determine boundary points of the imaging objects based on the position areas, determine the depth ranges of the imaging objects in the depth direction based on the depth information corresponding to the boundary points, and divide the original image into the plurality of layers based on the depth ranges of the imaging objects.

In some embodiments, the processing module 503 can be configured to determine the attribute information of the target object, determine the corresponding image processing strategy based on the attribute information, determine the to-be-processed area of the target objects in the corresponding target layers based on the depth information, perform processing in the to-be-processed area with the corresponding image processing strategy, and editing the processing result to obtain the frame of the target image.

The target layers and the target object can have a one-to-one correspondence. One or more target layers or the target objects can be provided.

In some embodiments, the processing module 503 can be further configured to perform trapezoidal correction on the first target object at the first target layer according to the depth information of the first target object.

In some embodiments, the processing module 503 can be further configured to erase the second target object at the target image layer where the second target object is located according to the depth information of the second target object, and perform erasing or blurring on the third target object at the target layer where the third target object is according to the depth information of the third target object.

For processing apparatus embodiments of embodiments of the present disclosure, since processing apparatus embodiments can correspond to the above method embodiments, the description can be relatively simple. For the related parts, reference can be made to the description of the above method embodiments, which are not repeated here.

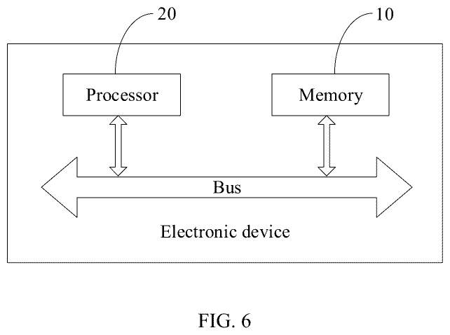

Embodiments of the present disclosure further provide an electronic device. FIG. 6 illustrates a schematic structural diagram of the electronic device according to some embodiments of the present disclosure. As shown in FIG. 6, the electronic device includes a memory 10, and a processor 20.

The memory 10 can be used to store computer instruction set. The computer instruction set can be used to be implemented through the computer program.

The processor 20 can be configured to execute the computer instruction set to implement the processing method embodiments above.

The processor 20 can include a central processing unit (CPU), an application-specific integrated circuit (ASIC), a ditial signal processor (DSP), a field programmable gate array (FPGA), a neural network processing unit (NPU), a deep learning processing unit (DPU), or another programmable logic device.

The electronic device can include a display apparatus and/or a display interface capable of connecting to an external display apparatus.

In some embodiments, the electronic device can further include a camera assembly and/or be connected to an external camera assembly.

In addition, the electronic device can further include a communication interface, a communication bus, etc. The memory, processor, and communication interface can communicate with each other via the communication bus.

The communication interface can be configured for communication between the electronic device and other devices. The communication bus can include a Peripheral Component Interconnect (PCI) bus, an Extended Industry Standard Architecture (EISA) bus, etc. The communication bus can be divided into an address bus, a data bus, and a control bus.

Embodiments of the present disclosure are described in a progressive manner. Each embodiment focuses on the differences from other embodiments. Similar parts between embodiments can be referred to each other.

To facilitate the description, the system or device can be divided into various modules or units based on functionality, which can be described separately. In embodiments of the present disclosure, the functions of the units can be implemented in one or more pieces of software and/or hardware.

Through the description above, those skilled in the art can clearly understand that the present disclosure can be implemented by using software and a necessary general-purpose hardware platform. Based on this understanding, the essence or the part making creative contributions of the technical solution of the present disclosure can be embodied in the form of a software product. The software product can be stored in a storage medium such as ROM/RAM, disk, CD-ROM, etc., including instructions used to enable a computer device (such as a personal computer, a server, or a network device, etc.) to execute the methods of embodiments or certain parts of embodiments of the present disclosure.

In the present disclosure, terms such as “first,” “second,” “third,” and “fourth” are used to distinguish one entity or operation from another, without necessarily implying any actual relationship or sequence between these entities or operations. In addition, terms such as “including,” “comprising,” or any other variations thereof are intended to encompass non-exclusive inclusion, such that a process, method, article, or device including a series of elements includes not only those elements but also other elements not explicitly listed, or elements inherent to the process, method, article, or device. When there is no more limitation, an element limited by the phrase “including a . . . ” does not exclude the presence of additional identical elements in the process, method, article, or device including the element.

The above are merely some embodiments of the present disclosure. For those skilled in the art, improvements and modifications can be made without departing from the principle of the present disclosure, and these improvements and modifications are within the scope of the present disclosure.

What is claimed is:

1. A processing method comprising:
obtaining a frame of an original image in a spatial environment;
based on depth information of imaging objects in the original image, associating the imaging objects with a plurality of layers of the original image, the plurality of layers having a difference in a depth direction;
performing corresponding image processing on a target object in a target layer according to the depth information to obtain a frame of a target image.

2. The method according to claim 1, wherein based on the depth information of the imaging objects in the original image, associating the imaging objects with the plurality of layers of the original image includes:
obtaining the depth information of the imaging objects of the original image through a sensor;
determining depth ranges of the imaging objects in the depth direction based on the depth information;
dividing the original image into the plurality of layers based on the depth ranges of the imaging objects to associate the imaging objects with the corresponding layers.

3. The method according to claim 1, wherein based on the depth information of the imaging objects in the original image, associating the imaging objects with the plurality of layers of the original image includes at least one of:
dividing the original image into the plurality of layers based on moving information and the depth information of the imaging objects to associate the imaging objects with the corresponding layers, the moving information representing moving statuses of the imaging objects;
dividing the original image into the plurality of layers based on position areas and the depth information of the imaging objects in the original image to associate the imaging objects with the corresponding layers; or
dividing the original image into the plurality of layers based on the moving information, the position areas, and the depth information to associate the imaging objects with the corresponding layers.

4. The method according to claim 3, wherein dividing the original image into the plurality of layers based on the moving information and the depth information of the imaging object includes at least one of:
determining contour information of the imaging objects based on the moving information and an object recognition algorithm;
determining depth ranges of the imaging objects based on the contour information and the corresponding depth information; or
dividing the original image into the plurality of layers based on the depth ranges of the imaging objects.

5. The method according to claim 3, wherein dividing the original image into the plurality of layers based on the position areas and the depth information includes:
determining boundary points of the imaging objects based on the position areas;
determining depth ranges of the imaging objects corresponding to the boundary points; and
dividing the original image into the plurality of layers based on the depth ranges of the imaging objects.

6. The method according to claim 1, wherein performing the corresponding image processing on the target object at the target layer according to the depth information to obtain the frame of the target image includes:
determining attribute information of the target object, and determining a corresponding image processing strategy based on the attribute information;
determining a to-be-processed area of the target object in the corresponding target layer based on the depth information to perform processing in the to-be-processed area according to the corresponding image processing strategy; and
editing a processing result to obtain the frame of the target image;
wherein:
one or more target layers or one or more target objects are provided; and
the one or more target layers are in a one-to-one correspondence with the one or more target objects.

7. The method according to claim 6, wherein performing the corresponding image processing on the target object at the target layer according to the depth information includes:
performing trapezoidal correction on a first target object in a first target layer according to depth information of the first target object.

8. The method according to claim 7, wherein performing the image processing on the target object at the target layer according to the depth information includes at one of:
erasing a second target object at a second target layer according to depth information of the second target object; or
erasing or blurring a third target object at a third target layer according to depth information of the third target object.

9. A processing apparatus comprising:
an acquisition module configured to obtain a frame of an original image in a spatial environment;
an association module configured to, based on depth information of imaging objects in the original image, associate the imaging objects with a plurality of layers of the original image, the plurality of layers having a difference in a depth direction; and
a processor configured to perform corresponding image processing on a target object in a target layer according to the depth information to obtain a frame of a target image.

10. The apparatus according to claim 9, wherein the association module is further configured to:
obtain the depth information of the imaging objects of the original image through a sensor;
determine depth ranges of the imaging objects in the depth direction based on the depth information;
divide the original image into the plurality of layers based on the depth ranges of the imaging objects to associate the imaging objects with the corresponding layers.

11. The apparatus according to claim 9, wherein the association module is further configured to:
divide the original image into the plurality of layers based on moving information and the depth information of the imaging objects to associate the imaging objects with the corresponding layers, the moving information representing moving statuses of the imaging objects;
divide the original image into the plurality of layers based on position areas and the depth information of the imaging objects in the original image to associate the imaging objects with the corresponding layers; or
divide the original image into the plurality of layers based on the moving information, the position areas, and the depth information to associate the imaging objects with the corresponding layers.

12. The apparatus according to claim 11, wherein the association module is further configured to:
determine contour information of the imaging objects based on the moving information and an object recognition algorithm;
determine depth ranges of the imaging objects based on the contour information and the corresponding depth information; or
divide the original image into the plurality of layers based on the depth ranges of the imaging objects.

13. An electronic device comprising:
one or more processors; and
one or more memories storing a computer instruction set that, when executed by the one or more processors, causes the one or more processors to:
obtain a frame of an original image in a spatial environment;
based on depth information of imaging objects in the original image, associate the imaging objects with a plurality of layers of the original image, the plurality of layers having a difference in a depth direction;
perform corresponding image processing on a target object in a target layer according to the depth information to obtain a frame of a target image.

14. The device according to claim 13, wherein the one or more processors are further configured to:
obtain the depth information of the imaging objects of the original image through a sensor;
determine depth ranges of the imaging objects in the depth direction based on the depth information; and
divide the original image into the plurality of layers based on the depth ranges of the imaging objects to associate the imaging objects with the corresponding layers.

15. The device according to claim 13, wherein the one or more processors are further configured to:
divide the original image into the plurality of layers based on moving information and the depth information of the imaging objects to associate the imaging objects with the corresponding layers, the moving information representing moving statuses of the imaging objects;
divide the original image into the plurality of layers based on position areas and the depth information of the imaging objects in the original image to associate the imaging objects with the corresponding layers; or
divide the original image into the plurality of layers based on the moving information, the position areas, and the depth information to associate the imaging objects with the corresponding layers.

16. The device according to claim 15, wherein the one or more processors are further configured to:
determine contour information of the imaging objects based on the moving information and an object recognition algorithm;
determine depth ranges of the imaging objects based on the contour information and the corresponding depth information; or
divide the original image into the plurality of layers based on the depth ranges of the imaging objects.

17. The device according to claim 15, wherein the one or more processors are further configured to:
determine boundary points of the imaging objects based on the position areas;
determine depth ranges of the imaging objects corresponding to the boundary points; and
divide the original image into the plurality of layers based on the depth ranges of the imaging objects.

18. The device according to claim 13, wherein the one or more processors are further configured to:
determine attribute information of the target object, and determine a corresponding image processing strategy based on the attribute information;
determine a to-be-processed area of the target object in the corresponding target layer based on the depth information to perform processing in the to-be-processed area according to the corresponding image processing strategy; and
edit a processing result to obtain the frame of the target image;
wherein:
one or more target layers or one or more target objects are provided; and
the one or more target layers are in a one-to-one correspondence with the one or more target objects.

19. The device according to claim 18, wherein the one or more processors are further configured to:
perform trapezoidal correction on a first target object in a first target layer according to depth information of the first target object.

20. The device according to claim 19, wherein the one or more processors are further configured to;
erasing a second target object at a second target layer according to depth information of the second target object; or
erasing or blurring a third target object at a third target layer according to depth information of the third target object.
